(19) United States
(12) Patent Application Publication
(10) Pub. No.: US 2025/0306849 A1
(43) Pub. Date: Oct. 2, 2025

(54) MUSIC SELECTION DEVICE, MUSIC SELECTION METHOD, AND STORAGE MEDIUM

(71) Applicant: HONDA MOTOR CO., LTD., TOKYO (JP)

(72) Inventors: Taiki YAMADA, TOKYO (JP); Daijiro MIYAMOTO, TOKYO (JP); Ryusuke TAMANAHA, TOKYO (JP); Kazuhide TAKAGI, TOKYO (JP)

(21) Appl. No.: 19/065,737

(22) Filed: Feb. 27, 2025

(30) Foreign Application Priority Data
Mar. 26, 2024 (JP) 2024-049523

(51) Int. Cl. G06F 3/16; G06F 3/01

(52) U.S. Cl. CPC G06F 3/165; G06F 3/011

(57) ABSTRACT

A music selection device includes an identifying unit that identifies an user who is an intention-unrespected user whose intention is not required to be respected when a musical piece is selected, from among a plurality of users located in a predetermined space, and a music selection unit that selects a musical piece to be provided to the users located in the predetermined space based on music-related information of a mobile terminal carried by an intention-respected user excluding the intention-unrespected user from the plurality of users located in the predetermined space.

### CROSS-REFERENCE TO RELATED APPLICATIONS

This application is based upon and claims the benefit of priority from Japanese Patent Application No. 2024-049523 filed on Mar. 26, 2024, the contents of which are incorporated herein by reference.

### BACKGROUND OF THE INVENTION

### Field of the Invention

The present disclosure relates to a music selection device, a music selection method, and a storage medium.

### Description of the Related Art

JP 2010-277251 A discloses an information output system for outputting information such as BGM suited to the tastes of a plurality of persons present in a predetermined area.

### SUMMARY OF THE INVENTION

A technique that can perform music selection more satisfactorily has been long awaited.

The present invention has the object of meeting the aforementioned need.

A music selection device according to a first aspect of the present disclosure includes an identifying unit configured to identify an intention-unrespected user whose intention is not required to be respected when a musical piece is selected, from among a plurality of users located in a predetermined space, and a music selection unit configured to, by excluding the intention-unrespected user from the plurality of users located in the predetermined space to identify an intention-respected user, select the musical piece to be provided to the plurality of users located in the predetermined space based on music-related information of a mobile terminal carried by the intention-respected user.

A music selection method according to a second aspect of the present disclosure includes the steps of an identifying step of identifying an intention-unrespected user whose intention is not required to be respected when a musical piece is selected, from among a plurality of users located in a predetermined space, and a music selection step of, by excluding the intention-unrespected user from the plurality of users located in the predetermined space to identify an intention-respected user, selecting the musical piece to be provided to the plurality of users located in the predetermined space based on music-related information of a mobile terminal carried by the intention-respected user.

A third aspect of the present disclosure is a program for causing a computer to execute the music selection method according to the second aspect.

According to the present invention, it is possible to select music more favorably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1A is a diagram illustrating an example of users located in a predetermined space;

FIG. 1B is a diagram illustrating an example of a music selection device;

FIG. 2 is a diagram for describing an example of acquiring user state information;

FIGS. 3A, 3B, 3C, and 3D are diagrams for describing examples of music-related information;

FIG. 4 is a flowchart illustrating an example of the operation of a music selection device;

FIG. 5 is a diagram for describing an example of input of intention-unrespected information.

FIG. 6 is a flowchart illustrating an example of the operation of the music selection device;

FIG. 7A is a diagram for describing an example of a communication history in a mobile terminal;

FIG. 7B is a diagram illustrating a correspondence between the degree of familiarity and the degree of popularity of a selected musical piece;

FIG. 8 is a flowchart illustrating an example of the operation of the music selection device;

FIG. 9A is a diagram for describing an example of acquiring biometric information;

FIG. 9B is a diagram illustrating an example of the number of beats of a musical piece selected in accordance with the heart rate of the intention-respected user;

FIG. 9C is a diagram illustrating an example of the number of beats of a musical piece selected in accordance with the amount of activity of the intention-respected user;

FIG. 9D is a diagram illustrating an example of the number of beats of a musical piece selected in accordance with the heart rate variability of the intention-respected user; and

FIG. 10 is a flowchart illustrating an example of the operation of the music selection device.

### DETAILED DESCRIPTION OF THE INVENTION

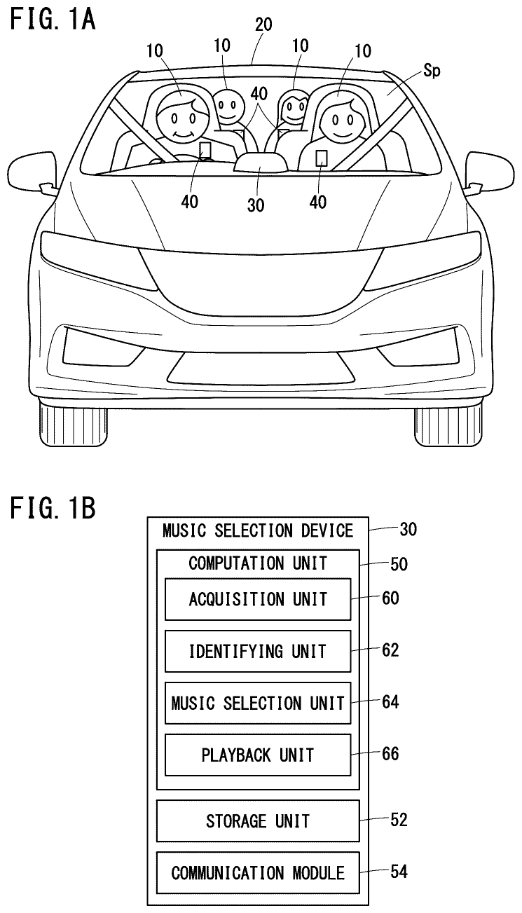

A music selection device according to an embodiment will be described with reference to the drawings. FIG. 1A is a diagram illustrating an example of users 10 located in a predetermined space Sp. In FIG. 1A, the predetermined space Sp is a space in a vehicle 20. In the present embodiment, the predetermined space Sp is a space in the vehicle 20, but the predetermined space Sp is not limited to such a space. The predetermined space Sp may be, for example, a space in a room.

In FIG. 1A, the plurality of users 10 are on board a vehicle 20. That is, the plurality of users 10 are located in the predetermined space Sp. A music selection device 30 is mounted on the vehicle 20. The music selection device 30 is provided in an in-vehicle audio device such as a display audio apparatus.

The music selection device 30 provides musical pieces to the plurality of users 10 located within a predetermined space Sp. The music selection device 30 plays back the musical pieces, whereby the musical pieces are provided. In the present embodiment, the musical pieces are provided by the music selection device 30 playing back the musical pieces, but the present invention is not limited to this feature. The musical pieces may be provided by the music selection device 30 distributing the musical pieces to mobile terminals 40 carried by the respective users 10 via communication. In this case, the mobile terminals 40 play back the distributed musical pieces.

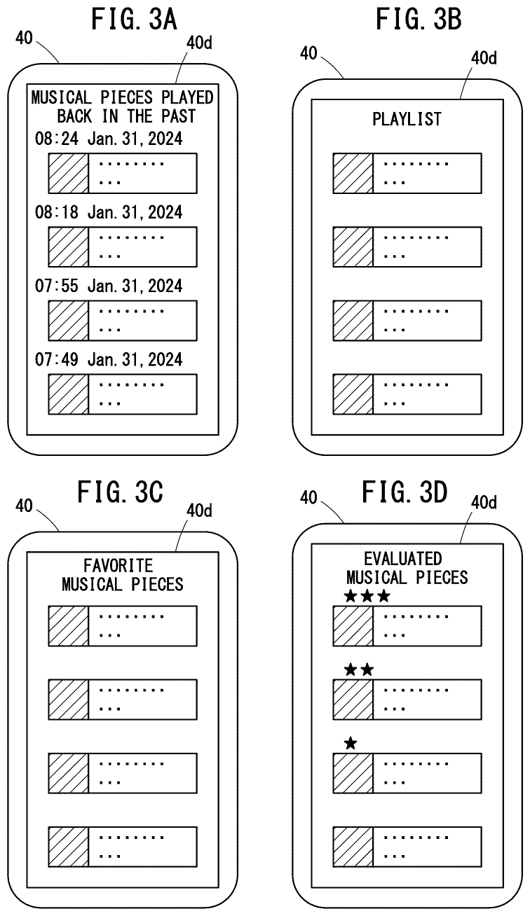

The music selection device 30 selects a musical piece to be provided, based on music-related information of the mobile terminal 40 carried by an intention-respected user excluding an intention-unrespected user from the plurality of users 10. The music-related information is information of musical pieces or lists of musical pieces stored in the mobile terminal 40. An example of the music-related information will be described later with reference to FIGS. 3A, 3B, and 3C.

The intention-respected user is a user 10 whose intention to provide music-related information used for music selection is respected when a musical piece is selected by the music selection device 30. The intention-unrespected user is a user 10 whose intention to provide music-related information used for music selection is not respected when a musical piece is selected by the music selection device 30. The intention-unrespected user further includes a user 10 who does not intend to provide music-related information.

FIG. 1B is a diagram illustrating an example of the music selection device 30. The music selection device 30 includes a computation unit 50, a storage unit 52, and a communication module 54. The computation unit 50 is a computer, and includes a processor such as a CPU (Central Processing Unit), a GPU (Graphics Processing Unit), or the like. That is, the computation unit 50 includes a processing circuitry.

The storage unit 52 is a computer readable storage medium. The storage unit 52 includes a volatile memory such as a RAM (Random Access Memory) and a non-volatile memory such as a ROM (Read Only Memory) or a flash memory. The volatile memory is used as a working memory of the processor. The non-volatile memory stores therein programs executed by the processor, and data of musical pieces and the like. That is, the music selection device 30 includes a program product of the programs executed by the processor.

By execution of a program stored in the storage unit 52, the music selection device 30 selects a musical piece, based on the music-related information of the mobile terminal 40 carried by the intention-respected user excluding the intention-unrespected user from the plurality of users 10.

The communication module 54 is used for communication between the music selection device 30 and the mobile terminals 40 carried by the users 10. In the present embodiment, for example, communication by Bluetooth (registered trademark) is used for wireless communication between the music selection device 30 and the mobile terminals 40, but the present invention is not limited to this. The communication module 54 can also be used for communication between the music selection device 30 and a distribution server for musical pieces (not shown) connected to the communication network.

The computation unit 50 includes an acquisition unit 60, an identifying unit 62, a music selection unit 64, and a playback unit 66. When the computation unit 50 executes a program stored in the storage unit 52, the acquisition unit 60, the identifying unit 62, the music selection unit 64, and the playback unit 66 are implemented. At least a portion of the acquisition unit 60, the identifying unit 62, the music selection unit 64, and the playback unit 66 may be implemented by an integrated circuit such as an ASIC (Application Specific Integrated Circuit) or an FPGA (Field Programmable Gate Array), or an electronic circuit including a discrete device.

The acquisition unit 60 acquires user state information of the plurality of users 10. The user state information is information relating to the states of the plurality of users 10 located in the predetermined space Sp. In the present embodiment, the user state information is information indicating whether or not the user 10 is sleeping, but the user state information is not limited to this feature.

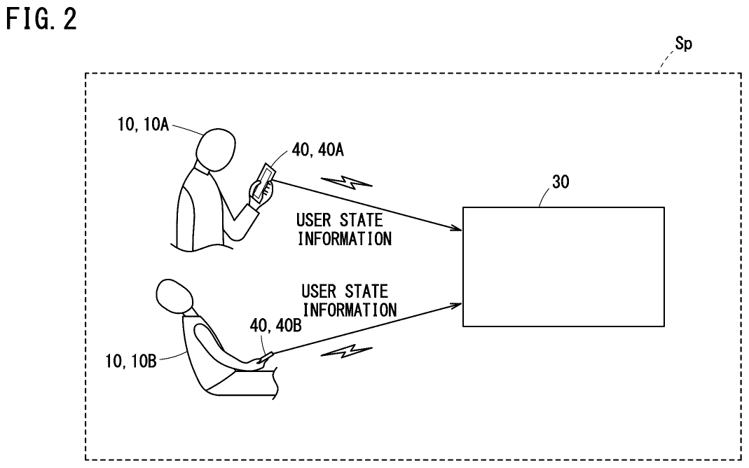

The mobile terminal 40 carried by the user 10 can acquire the biometric information on the heart rate, the amount of activity, the respiration rate, the degree of eyelid opening, and the like of the user 10. The mobile terminal 40 can determine whether or not the user 10 carrying the mobile terminal 40 is sleeping, on the basis of the biometric information. An example of the determination will be described later with reference to FIG. 2. The acquisition unit 60 acquires the user state information indicating the determination result of the determination from the mobile terminal 40 of each of the users 10 by communication via the communication module 54.

The acquisition unit 60 further acquires music-related information of the mobile terminal 40 carried by an intention-respected user from among the users 10. The music-related information is acquired from the mobile terminal 40 of the intention-respected user by communication via the communication module 54.

The identifying unit 62 identifies an intention-unrespected user from among the plurality of users 10. The intention-unrespected user is identified based on the user state information acquired by the acquisition unit 60. It is considered that a user 10 sleeping in the predetermined space Sp among the plurality of users 10 does not listen to the musical piece selected by the music selection device 30. Therefore, the sleeping user is identified as the intention-unrespected user. The intention-respected user is a user 10 remaining after excluding the intention-unrespected user from the plurality of users 10. That is, among the plurality of users 10, a non-sleeping user who is not sleeping in the predetermined space Sp is an intention-respected user.

The music selection unit 64 selects a musical piece to be provided to a plurality of users 10 located in the predetermined space Sp, based on music-related information of the mobile terminals 40 carried by the intention-respected user. When data of a plurality of musical pieces is stored in the storage unit 52, the music selection unit 64 may select a musical piece to be provided to the plurality of users 10 from among a plurality of musical pieces corresponding to the stored data. The music selection unit 64 may select a musical piece to be provided to the plurality of users 10 from among a plurality of musical pieces that can be distributed from the distribution server for musical pieces to the music selection device 30. The playback unit 66 plays back the musical piece selected by the music selection unit 64.

FIG. 2 is a diagram for describing an example of acquiring user state information. The mobile terminal 40 carried by the user 10 is provided with sensors and the like including a heart rate sensor, an acceleration sensor, and an image sensor. The mobile terminal 40 can acquire the biometric information on the heart rate, the amount of activity, the respiration rate, the degree of eyelid opening, and the like of the user 10 by using the sensors and the like.

FIG. 2 shows two users 10 as the plurality of users 10 and the mobile terminals 40 carried by the respective users 10. One of the two users 10 is a non-sleeping user 10A who is not sleeping. Another of the two users 10 is a sleeping user 10B.

A mobile terminal 40A carried by the non-sleeping user 10A determines that the non-sleeping user 10A is not sleeping based on the biometric information of the non-sleeping user 10A. The acquisition unit 60 acquires user state information indicating that the non-sleeping user 10A is not sleeping from the mobile terminal 40A. A mobile terminal 40B carried by the sleeping user 10B determines that the sleeping user 10B is sleeping based on the biometric information of the sleeping user 10B. The acquisition unit 60 acquires user state information indicating that the sleeping user 10B is sleeping from the mobile terminal 40B.

It is assumed that the sleeping user 10B does not listen to a musical piece selected by the music selection device 30. Accordingly, the identifying unit 62 identifies the sleeping user 10B among the two users 10 as an intention-unrespected user, based on the user state information acquired by the acquisition unit 60. In this way, it is possible to easily identify the intention-unrespected user. The non-sleeping user 10A, who is a remaining user 10 after excluding the intention-unrespected user from the two users 10, is an intention-respected user. As described above, the acquisition unit 60 acquires the music-related information of the mobile terminal 40 carried by the intention-respected user.

FIGS. 3A, 3B, 3C, and 3D are diagrams for describing examples of music-related information. The mobile terminal 40 carried by the user 10 can store the musical piece playback history information indicating the playback history of musical pieces by the user 10 together with the time information indicating the playback time of each musical piece. The musical piece playback history information is an example of music-related information. The playback history of musical pieces indicates the musical pieces played back by the mobile terminal 40 in the past.

The musical piece playback history information includes information on the titles of musical pieces played back in the past, information on the musicians of the musical pieces, data on the album cover images of the musical pieces, information on the genres of the musical pieces, and the like. When the musical piece includes lyrics, the musical piece playback history information may further include a part or all of the data of the lyrics.

When the musical piece includes lyrics, the musician of the musical piece is, for example, a singer, a songwriter, a performer, a composer, or the like of the musical piece. When the musical piece does not include lyrics, the musician of the musical piece is, for example, a performer, a composer, or the like of the musical piece. The musician of the musical piece may be, for example, a producer of the musical piece.

FIG. 3A illustrates an example of a state in which the playback history of musical pieces indicated by the musical piece playback history information is displayed on a display portion 40d of the mobile terminal 40 in the case where the musical piece playback history information is stored in the mobile terminal 40. As the playback history of musical pieces, for example, the title of the musical piece, the musician of the musical piece, and the album cover image of the musical piece, are displayed in chronological order for each musical piece.

The music preference of an intention-respected user can be grasped based on the musical piece playback history information of the intention-respected user acquired by the acquisition unit 60. For example, it is possible to grasp the musical pieces preferred by the intention-respected user, together with the degree of preference of the musical pieces by the intention-respected user, based on the number of times each musical piece is recorded in the playback history of musical pieces. It is possible to grasp the musicians preferred by the intention-respected user, together with the degree of preference of the musicians by the intention-respected user, based on the number of times the musical pieces by each musician is recorded in the playback history of musical pieces.

It is possible to grasp the genres preferred by the intention-respected user, together with the degree of preference of the genres by the intention-respected user, based on the number of times the musical pieces of each genre are recorded in the playback history of musical pieces. The music selection unit 64 selects a musical piece based on the music preference of the intention-respected user, which is grasped based on the musical piece playback history information.

The mobile terminal 40 carried by the user 10 can store playlist information indicating a playlist created by the user 10. The playlist information is an example of music-related information. The playlist information includes information on titles of the musical pieces, information on musicians of the musical pieces, data on album cover images of the musical pieces, information on genres of the musical pieces, and the like. When the musical piece includes lyrics, the playlist information may further include a part or all of the data of the lyrics.

FIG. 3B illustrates an example of a state in which the playlist indicated by the playlist information is displayed on the display portion 40d of the mobile terminal 40 in the case where the playlist information is stored in the mobile terminal 40. As the playlist, for example, the title of the musical piece, the musician of the musical piece, and the album cover image of the musical piece are displayed for each musical piece.

As in the case where the musical piece playback history information is acquired, the music preference of the intention-respected user can be grasped based on the playlist information of the intention-respected user acquired by the acquisition unit 60. The music selection unit 64 selects a musical piece based on the music preference of the intention-respected user, which is grasped based on the playlist information.

The mobile terminal 40 carried by the user 10 can store favorite musical piece information indicating a favorite musical piece set as a favorite by the user 10. The favorite musical piece information is an example of music-related information. The favorite musical piece information includes information on titles of the musical pieces, information on musicians of the musical pieces, data on album cover images of the musical pieces, information on genres of the musical pieces, and the like. When the musical piece includes lyrics, the favorite musical piece information may further include a part or all of the data of the lyrics.

FIG. 3C illustrates an example of a state in which the favorite musical pieces indicated by the favorite musical piece information are displayed on the display portion 40d of the mobile terminal 40 in the case where the favorite musical piece information is stored in the mobile terminal 40. As the favorite musical pieces, for example, the title of the musical piece, the musician of the musical piece, and the album cover image of the musical piece are displayed for each musical piece.

As in the case where the musical piece playback history information or the playlist information is acquired, the music preference of the intention-respected user can be grasped based on the favorite musical piece information of the intention-respected user acquired by the acquisition unit 60. The music selection unit 64 selects a musical piece based on the music preference of the intention-respected user, which is grasped based on the favorite musical piece information.

The mobile terminal 40 carried by the user 10 can store evaluated musical piece information indicating the evaluated musical piece of which the user 10 has given an evaluation. The evaluated musical piece information is an example of music-related information. The evaluated musical piece is given an evaluation in a plurality of grades, for example, four grades. The evaluated musical piece information includes information on titles of the musical piece, information on musicians of the musical piece, data on album cover images of the musical piece, information on genres of the musical piece, and the like. When the musical piece includes lyrics, the evaluated musical piece information may further include a part or all of the data of the lyrics.

FIG. 3D illustrates an example of a state in which the evaluated musical pieces indicated by the evaluated musical piece information are displayed on the display portion 40d of the mobile terminal 40 in the case where the evaluated musical piece information is stored in the mobile terminal 40. As the evaluated musical pieces, for example, the title of the musical piece, the musician of the musical piece, and the album cover image of the musical piece are displayed together with the evaluation for each musical piece.

In the example shown in FIG. 3D, the evaluation given to each musical piece is based on a four grades. In the case that three stars are displayed on the musical piece indication, the user 10 gives the highest evaluation among the four grades to the musical piece. In the case that no star is displayed on the musical piece indication, the user 10 gives the lowest evaluation among the four grades to the musical piece.

As in the case where the musical piece playback history information, the playlist information, or the favorite musical piece information is acquired, the music preference of the intention-respected user can be grasped based on the evaluated musical piece information of the intention-respected user acquired by the acquisition unit 60. The music selection unit 64 selects a musical piece based on the music preference of the intention-respected user, which is grasped based on the evaluated musical piece information. By using the musical piece playback history information, the playlist information, the favorite musical piece information or the evaluated musical piece information as the music-related information, it is possible to select a musical piece that can be more preferred by the intention-respected user.

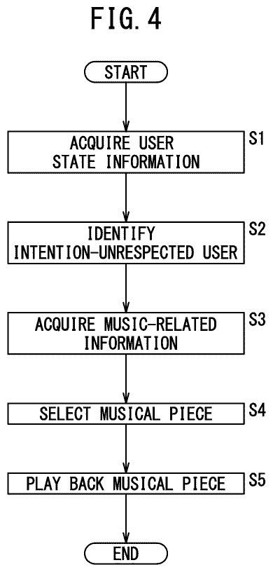

FIG. 4 is a flowchart illustrating an example of the operation of the music selection device 30. FIG. 4 shows a processing sequence of the music selection method by the music selection device 30. The processing sequence is performed by the computation unit 50 of the music selection device 30 executing a program stored in the storage unit 52.

When the present processing sequence is started, in step S1, the acquisition unit 60 acquires the user state information of the plurality of users 10 located in the predetermined space Sp from the mobile terminal 40 carried by each of the users 10. In step S2, the identifying unit 62 identifies an intention-unrespected user among the plurality of users 10 based on the user state information acquired in step S1. In step S3, the acquisition unit 60 acquires music-related information of the mobile terminal 40 carried by the intention-respected user excluding the intention-unrespected user identifies in step S2 from the plurality of users 10.

In step S4, the music selection unit 64 selects a musical piece to be provided to the plurality of users 10 located in the predetermined space Sp, based on the music preference of the intention-respected user grasped based on the music-related information acquired in step S3. In step S5, the playback unit 66 plays back the musical piece selected in step S4. When the processing of step S5 is completed, this processing sequence is terminated.

In the present embodiment, a musical piece is selected based on the music-related information of the mobile terminal 40 carried by an intention-respected user excluding an intention-unrespected user from the plurality of users 10 located in the predetermined space Sp. It is possible to select a musical piece favorably since the musical piece is selected without depending on the intention-unrespected user's music-related information.

The above-described embodiment may be modified in the following manner. In exemplary modifications described below, descriptions that overlap or are duplicative of those in the embodiment will be omitted.

### Modification 1

In the above-described embodiment, the identifying unit 62 identifies the sleeping user 10B as the intention-unrespected user among the plurality of users 10 located in the predetermined space Sp, but the present invention is not limited to this feature. The identifying unit 62 may identify, as the intention-unrespected user, the user 10 who has input intention-unrespected information to the own mobile terminal 40 among the plurality of users 10. The intention-unrespected information is information indicating that the user is an intention-unrespected user.

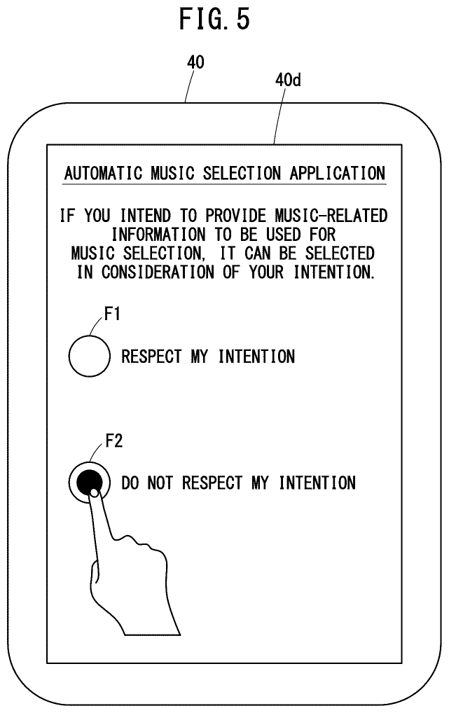

FIG. 5 is a diagram for describing an example of inputting intention-unrespected information. FIG. 5 illustrates a state where a screen on which the intention-unrespected information can be input is displayed on the display portion 40d of the mobile terminal 40 carried by each of the users 10. The display portion 40d displays a message indicating that if there is an intention to provide the music-related information to be used for music selection to the music selection device 30, the musical piece can be selected in consideration of the intention.

The user 10 checks a checkbox F1 corresponding to a choice that the intention is required to be respected or a checkbox F2 corresponding to a choice that the intention is not required to be respected. When the user 10 checks the checkbox F2, the intention-unrespected information is input. In this case, the acquisition unit 60 acquires the intention-unrespected information input to the mobile terminal 40 from the mobile terminal 40. The intention-unrespected information is input to the music selection device 30 through the mobile terminal 40. In this way, it is possible to clearly identify the intention-unrespected user. The identifying unit 62 identifies the intention-unrespected user based on the input intention-unrespected information.

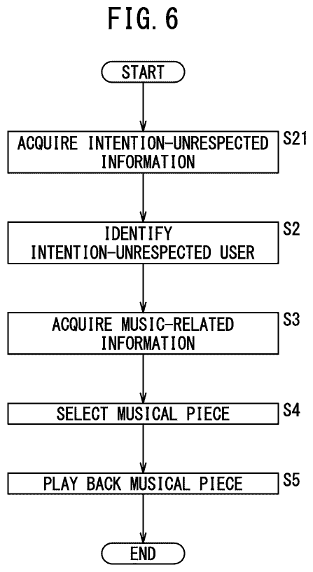

FIG. 6 is a flowchart illustrating an example of the operation of the music selection device 30. FIG. 6 shows a processing sequence of the music selection method by the music selection device 30. The processing sequence is performed by the computation unit 50 of the music selection device 30 executing a program stored in the storage unit 52. The same reference numerals are assigned to the same steps as those described above with reference to FIG. 4, and the detailed description thereof is omitted as appropriate.

When the present processing sequence is started, in step S21, the acquisition unit 60 acquires the intention-unrespected information from the mobile terminal 40 to which the intention-unrespected information has been input. When the processing of step S21 is completed, the processing sequence proceeds to step S2. The processing performed in and after step S2 is the same as that in FIG. 4.

### Modification 2

In the above-described embodiment, the music selection unit 64 selects a musical piece based on the music-related information of the mobile terminal 40 carried by the intention-respected user, but the present invention is not limited to this feature. The music selection unit 64 may select a musical piece based on the degree of familiarity (intimacy) between the intention-respected users. The degree of familiarity between the intention-respected users is grasped based on the communication history of the mobile terminal 40 carried by the intention-respected user. The degree of familiarity can be grasped with high accuracy based on the communication history.

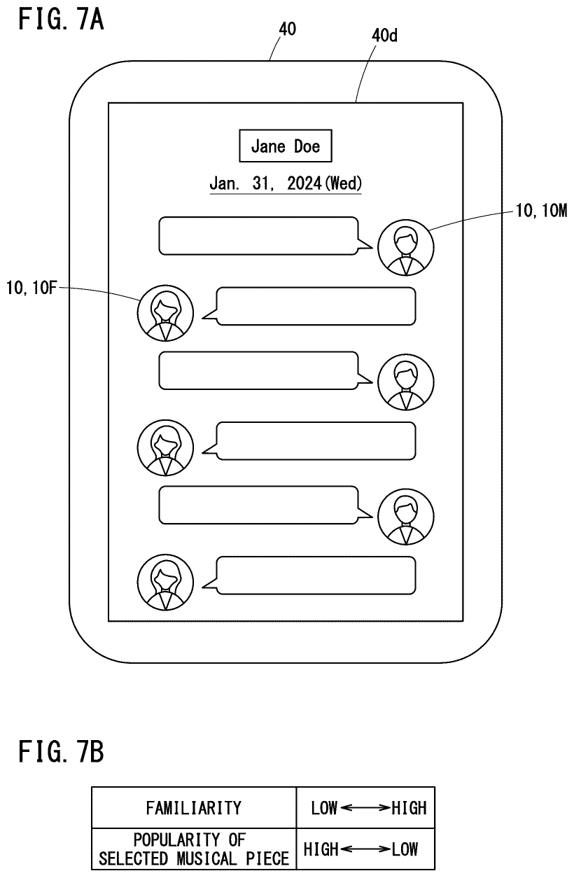

FIG. 7A is a diagram for describing an example of a communication history in a mobile terminal 40. FIG. 7A illustrates a state in which the communication history between a user 10M and a user 10F using a message application is displayed on a display portion 40d of the mobile terminal 40 of the user 10M. It is understood that the higher the frequency of the communication history, the higher the degree of familiarity between the user 10M and the user 10F. According to Modification 2, an example in which the degree of familiarity is grasped based on the communication history using the message application is described, but the degree of familiarity may be grasped based on another communication history such as a communication history by telephone.

An acquisition unit 60 acquires the communication history of the mobile terminal 40 carried by intention-respected user. A music selection unit 64 determines the degree of familiarity between the intention-respected users. The music selection unit 64 selects a musical piece based on the music-related information of the mobile terminal 40 carried by the intention-respected user, and also based on the degree of familiarity. The music selection unit 64 selects a musical piece in consideration of the degree of popularity of the musical piece according to the degree of familiarity. The degree of popularity of a musical piece can be grasped by using, for example, the number of times the musical piece is played back, the ranking of the number of times the musical piece is played back, the ranking of the musical piece on the music chart, and the like.

FIG. 7B is a diagram illustrating a correspondence between the degree of familiarity and the degree of popularity of a selected musical piece. When the degree of familiarity between the intention-respected users is low, selecting a musical piece having a high degree of popularity causes the intention-respected users who listen to the selected musical piece to accept the musical piece, and a comfortable atmosphere can be created between the intention-respected users.

When the degree of familiarity between the intention-respected users is high, selecting a musical piece having a low degree of popularity causes the intention-respected users to feel empathy with the selected musical piece, and the intention-respected users who listen to the musical piece is highly likely to be satisfied. Accordingly, as shown in FIG. 7B, the lower the degree of familiarity between the intention-respected users becomes, the higher the degree of popularity of the selected musical piece is. The higher the degree of familiarity between the intention-respected users becomes, the lower the degree of popularity of the selected musical piece is. In accordance with this feature, it is possible to select musical pieces that maintain a good atmosphere between the intention-respected users.

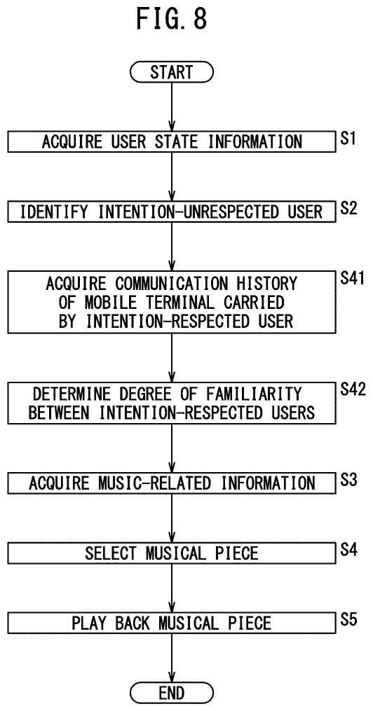

FIG. 8 is a flowchart illustrating an example of the operation of a music selection device 30. FIG. 8 shows a processing sequence of the music selection method by the music selection device 30. The processing sequence is performed by a computation unit 50 of the music selection device 30 executing a program stored in a storage unit 52. The same reference numerals are assigned to the same steps as those described above with reference to FIG. 4, and the detailed description thereof is omitted as appropriate.

When the processing of step S2 is completed, in step S41, the acquisition unit 60 acquires the communication history of the mobile terminal 40 carried by the intention-respected user from the mobile terminal 40. In step S42, the music selection unit 64 determines the degree of familiarity between the intention-respected users based on the communication history acquired in step S41. When the processing of step S42 is completed, the processing sequence proceeds to step S3. The processing performed in and after step S3 is the same as that in FIG. 4.

### Modification 3

In the above-described embodiment, the music selection unit 64 selects a musical piece based on the music-related information of the mobile terminal 40 carried by the intention-respected user, but the present invention is not limited to this feature. The music selection unit 64 may select a musical piece further based on the biometric information of the intention-respected user.

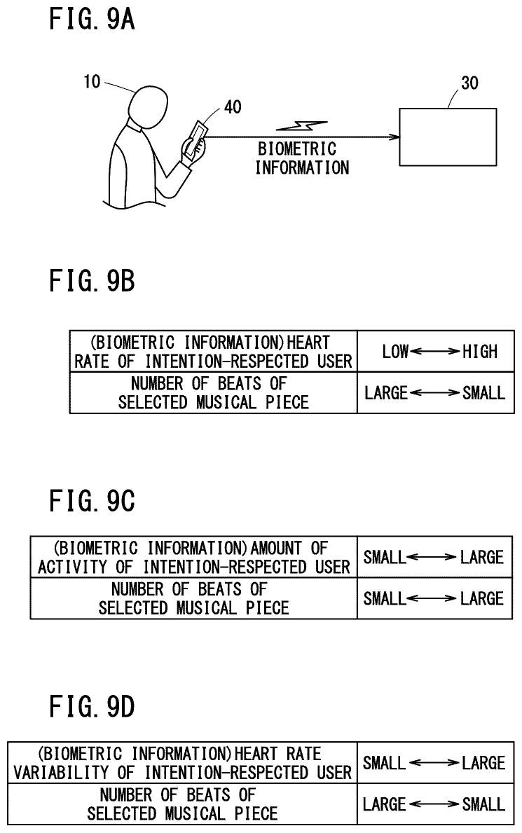

FIG. 9A is a diagram for describing an example of acquiring biometric information. As described above, the mobile terminal 40 carried by the user 10 is provided with sensors and the like including a heart rate sensor and an acceleration sensor. The mobile terminal 40 can acquire the biometric information on the heart rate, the amount of activity, the heart rate variability, etc. of the user 10 by using the sensors and the like. An acquisition unit 60 of the music selection device 30 acquires the biometric information of an intention-respected user from the mobile terminal 40 carried by the intention-respected user.

The music selection unit 64 selects a musical piece based on the music-related information of the mobile terminal 40 carried by the intention-respected user, and also based on the biometric information. The biometric information acquired by the acquisition unit 60 may change according to a mental state of the intention-respected user, who is an object of the biometric information that has been acquired. The number of beats of the musical piece selected by the music selection unit 64 is changed in accordance with the mental state, whereby the musical piece suitable for the mental state can be provided.

FIG. 9B is a diagram illustrating an example of the number of beats of a musical piece selected in accordance with the heart rate of an intention-respected user. If the heart rate of the intention-respected user is low, the intention-respected user may be feeling depressed. In this case, a musical piece having a large number of beats is selected so as to restore the mood of the intention-respected user. If the heart rate of the intention-respected user is high, the intention-respected user may be nervous. In this case, a musical piece having a small number of beats is selected so as to relax the intention-respected user by reducing the tension of the intention-respected user.

If the heart rate of the intention-respected user is low, the intention-respected user may be relaxed. In this case, a musical piece having a small number of beats may be selected in accordance with the mood of the intention-respected user. If the heart rate of the intention-respected user is high, the intention-respected user may be feeling high. In this case, a musical piece having a large number of beats may be selected in accordance with the mood of the intention-respected user.

FIG. 9C is a diagram illustrating an example of the number of beats of a musical piece selected in accordance with the amount of activity of an intention-respected user. When the amount of activity of the intention-respected user is small, the intention-respected user may be relaxed. In this case, a musical piece having a small number of beats is selected in accordance with the mood of the intention-respected user. When the amount of activity of the intention-respected user is large, the intention-respected user may be feeling high. In this case, a musical piece having a large number of beats is selected in accordance with the mood of the intention-respected user.

FIG. 9D is a diagram illustrating an example of the number of beats of a musical piece selected in accordance with the heart rate variability of an intention-respected user. If the heart rate variability of the intention-respected user is small, the intention-respected user may be feeling bored. In this case, a musical piece having a large number of beats is selected so as to alleviate boredom of the intention-respected user. If the heart rate variability of the intention-respected user is large, the intention-respected user may be feeling stressed. In this case, a musical piece having a small number of beats is selected so as not to promote the stress of the intention-respected user.

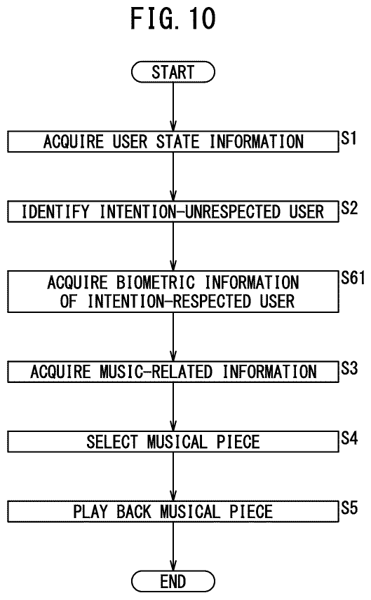

FIG. 10 is a flowchart illustrating an example of the operation of the music selection device 30. FIG. 10 shows a processing sequence of the music selection method by the music selection device 30. The processing sequence is performed by a computation unit 50 of the music selection device 30 executing a program stored in a storage unit 52. The same reference numerals are assigned to the same steps as those described above with reference to FIG. 4, and the detailed description thereof is omitted as appropriate.

When the processing of step S2 is completed, in step S61, the acquisition unit 60 acquires the biometric information of the intention-respected user from the mobile terminal 40 carried by the intention-respected user. When the processing of step S61 is completed, the processing sequence proceeds to step S3. The processing performed in and after step S3 is the same as that in FIG. 4.

With respect to the above embodiment and its modifications, the following supplementary notes are disclosed.

### Supplementary Note 1

The music selection device (30) according to the present disclosure includes the identifying unit (62) configured to identify the intention-unrespected user that is the user (10) whose intention is not required to be respected when the musical piece is selected, from among the plurality of users located in a predetermined space (Sp), and the music selection unit (64) configured to, by excluding the intention-unrespected user from the plurality of users located in the predetermined space to identify the intention-respected user, select the musical piece to be provided to the plurality of users located in the predetermined space based on the music-related information of the mobile terminal (40) carried by the intention-respected user. In accordance with such a configuration, it is possible to select a musical piece favorably since the musical piece is selected without depending on the intention-unrespected user's music-related information.

### Supplementary Note 2

The music selection device according to Supplementary Note 1 may further include the acquisition unit (60) configured to acquire the user state information which is information on a state of at least one of the plurality of users located in the predetermined space, the intention-unrespected user may be identified based on the user state information that has been acquired by the acquisition unit. In accordance with such a configuration, it is possible to easily identify the intention-unrespected user.

### Supplementary Note 3

In the music selection device according to Supplementary Note 1, the intention-unrespected user may be at least one of the plurality of users that is sleeping in the predetermined space. In accordance with such a configuration, a user who does not listen to a musical piece selected by the music selection device can be identified as the intention-unrespected user.

### Supplementary Note 4

In the music selection device according to Supplementary Note 1, at least one of the plurality of users may be capable of inputting the intention-unrespected information indicating that the one of the plurality of users is the intention-unrespected user, through the mobile terminal carried by the one of the plurality of users, and the identifying unit may identify the intention-unrespected user based on the intention-unrespected information. In accordance with such a configuration, it is possible to clearly identify the intention-unrespected user.

### Supplementary Note 5

In the music selection device according to Supplementary Note 1, the music selection unit may select the musical piece further based on the degree of familiarity between the intention-respected users. In accordance with such a configuration, it is possible to select a musical piece that maintains a good atmosphere between the intention-respected users.

### Supplementary Note 6

In the music selection device according to Supplementary Note 5, the degree of familiarity may be grasped based on the communication history of the mobile terminal. In accordance with such a configuration, the degree of familiarity can be grasped with high accuracy.

### Supplementary Note 7

The music selection device according to Supplementary Note 1 may further include the acquisition unit (60) configured to acquire the biometric information of the intention-respected user, and the music selection unit may select the musical piece further based on the biometric information that has been acquired by the acquisition unit. In accordance with such a configuration, it is possible to provide a musical piece suitable for the mental state of the intention-respected user.

### Supplementary Note 8

In the music selection device according to Supplementary Note 1, the music-related information may include any of information indicating a playback history of musical pieces of the intention-respected user, information indicating a playlist created by the intention-respected user, information indicating a favorite musical piece set as a favorite by the intention-respected user, and information indicating an evaluated musical piece an evaluation of which has been given by the intention-respected user, and the music selection unit may select the musical piece based on the music preference of the intention-respected user grasped based on the music-related information. In accordance with such a configuration, it is possible to select a musical piece that can be more preferred by the intention-respected user.

### Supplementary Note 9

The music selection method according to the present disclosure includes the steps of the identifying step of identifying the intention-unrespected user whose intention is not required to be respected when the musical piece is selected, from among the plurality of users located in the predetermined space, and the music selection step of, by excluding the intention-unrespected user from the plurality of users located in the predetermined space to identify the intention-respected user, selecting the musical piece to be provided to the plurality of users located in the predetermined space based on music-related information of the mobile terminal carried by the intention-respected user. In accordance with such a configuration, it is possible to select a musical piece favorably since the musical piece is selected without depending on the intention-unrespected user's music-related information.

### Supplementary Note 10

The program of the present disclosure is the program for causing the computer to execute the music selection method according to Supplementary Note 9. In accordance with such a configuration, it is possible to select a musical piece favorably since the musical piece is selected without depending on the intention-unrespected user's music-related information.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of each of the operations and the order of each of the processes are shown as examples, and the present invention is not limited to such operations and processes. The same applies to the case where numerical values or mathematical expressions are used in the description of the above-described embodiments.

1. A music selection device comprising one or more processors that execute computer-executable instructions stored in a memory,
wherein the one or more processors execute the computer-executable instructions to cause the music selection device to:
identify an intention-unrespected user whose intention is not required to be respected when a musical piece is selected, from among a plurality of users located in a predetermined space; and
by excluding the intention-unrespected user from the plurality of users located in the predetermined space to identify an intention-respected user, select the musical piece to be provided to the plurality of users located in the predetermined space based on music-related information of a mobile terminal carried by the intention-respected user.

2. The music selection device according to claim 1, wherein the one or more processors execute the computer-executable instructions to cause the music selection device to:
acquire user state information which is information on a state of at least one of the plurality of users located in the predetermined space; and
identify the intention-unrespected user based on the user state information that has been acquired.

3. The music selection device according to claim 1, wherein the intention-unrespected user is at least one of the plurality of users that is sleeping in the predetermined space.

4. The music selection device according to claim 1, wherein at least one of the plurality of users is capable of inputting intention-unrespected information indicating that the one of the plurality of users is the intention-unrespected user, through a mobile terminal carried by the one of the plurality of users, and
the one or more processors cause the music selection device to identify the intention-unrespected user based on the intention-unrespected information.

5. The music selection device according to claim 1, wherein the one or more processors cause the music selection device to select the musical piece further based on a degree of familiarity between the intention-respected users.

6. The music selection device according to claim 5, wherein the degree of familiarity is grasped based on a communication history of the mobile terminal.

7. The music selection device according to claim 1, wherein the one or more processors execute the computer-executable instructions to further cause the music selection device to:
acquire biometric information of the intention-respected user; and
select the musical piece further based on the biometric information that has been acquired.

8. The music selection device according to claim 1, wherein the music-related information includes any of information indicating a playback history of musical pieces of the intention-respected user, information indicating a playlist created by the intention-respected user, information indicating a favorite musical piece set as a favorite by the intention-respected user, and information indicating an evaluated musical piece an evaluation of which has been given by the intention-respected user, and
the one or more processors cause the music selection device to select the musical piece based on a music preference of the intention-respected user grasped based on the music-related information.

9. A music selection method comprising:
identifying an intention-unrespected user whose intention is not required to be respected when a musical piece is selected, from among a plurality of users located in a predetermined space; and
by excluding the intention-unrespected user from the plurality of users located in the predetermined space to identify an intention-respected user, selecting the musical piece to be provided to the plurality of users located in the predetermined space based on music-related information of a mobile terminal carried by the intention-respected user.

10. A non-transitory computer-readable storage medium storing a program for causing a computer to execute the music selection method according to claim 9.
